(19) United States
(12) Patent Application Publication
(10) Pub. No.: US 2026/0245924 A1
(43) Pub. Date: Aug. 20, 2026

(54) Fuel Cell Device

(71) Applicant: HONDA MOTOR CO., LTD., TOKYO (JP)

(72) Inventors: Naoki TAKAHASHI, WAKO-SHI (JP); Eisuke MATSUDA, WAKO-SHI (JP)

(21) Appl. No.: 19/538,218

(22) Filed: Feb. 12, 2026

(30) Foreign Application Priority Data
Feb. 18, 2025 (JP) 2025-023978

(51) Int. Cl. H01M 8/04007; H01M 8/04089; H01M 8/2475; H01M 8/248; H01M 8/10

(52) U.S. Cl. CPC H01M 8/04074; H01M 8/04089; H01M 8/2475; H01M 8/248; H01M 2008/1095

(57) ABSTRACT

A fuel cell device includes: a fuel cell stack formed by stacking a plurality of power generation cells on each other; a stack case that accommodates the fuel cell stack; and an electrical equipment case that is located above the fuel cell stack, is attached to the stack case, and accommodates electrical equipment. A cooling medium flow path through which a cooling medium can flow is formed in the electrical equipment case.

### CROSS-REFERENCE TO RELATED APPLICATIONS

This application is based upon and claims the benefit of priority from Japanese Patent Application No. 2025-023978 filed on Feb. 18, 2025, the contents of which are incorporated herein by reference.

### BACKGROUND OF THE INVENTION

### FIELD OF THE INVENTION

The present disclosure relates to a fuel cell device.

### DESCRIPTION OF THE RELATED ART

In recent years, technological developments have been conducted on fuel cell devices that contribute to energy efficiency in order to ensure that more people have access to affordable, reliable, sustainable and modern energy.

For example, JP 6696794 B2 discloses a configuration in which an electrical equipment case is attached to an outer surface of a stack case that accommodates a fuel cell stack. The electrical equipment case accommodates a high-voltage component to which electric power generated by the fuel cell stack is supplied.

### SUMMARY OF THE INVENTION

There has been a demand for a more satisfactory fuel cell device.

The present disclosure has the object of solving the above-described problem.

An aspect of the present disclosure is characterized by a fuel cell device comprising: a fuel cell stack including a plurality of power generation cells stacked on each other; a stack case configured to accommodate the fuel cell stack; and an electrical equipment case that is located above the fuel cell stack, is attached to the stack case, and is configured to accommodate electrical equipment, wherein a cooling medium flow path through which a cooling medium is allowed to flow is formed in the electrical equipment case.

According to the present disclosure, a more satisfactory fuel cell device can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an exploded perspective view of a fuel cell device according to an embodiment;

FIG. 2 is a top view of the fuel cell device;

FIG. 3 is a partially omitted cross-sectional view of an electrical equipment case;

FIG. 4 is a partially omitted cross-sectional view taken along line IV-IV of FIG. 2; and

FIG. 5 is a partially omitted cross-sectional view taken along line V-V of FIG. 2.

### DETAILED DESCRIPTION OF THE INVENTION

For example, in the case where an electrical equipment case attached to a stack case is located above a fuel cell stack, the heat generated in the fuel cell stack is easily transferred to the electrical equipment accommodated in the electrical equipment case, and thus the temperature of the electrical equipment may become excessively high. The present disclosure can provide a fuel cell device capable of suppressing an excessive increase in the temperature of electrical equipment.

A fuel cell device 10 according to an embodiment of the present disclosure will be described below with reference to the drawings. The fuel cell device 10 can be mounted on a vehicle (not shown) such as a fuel cell electric vehicle. The fuel cell device 10 may be mounted on a stationary power generation system or the like.

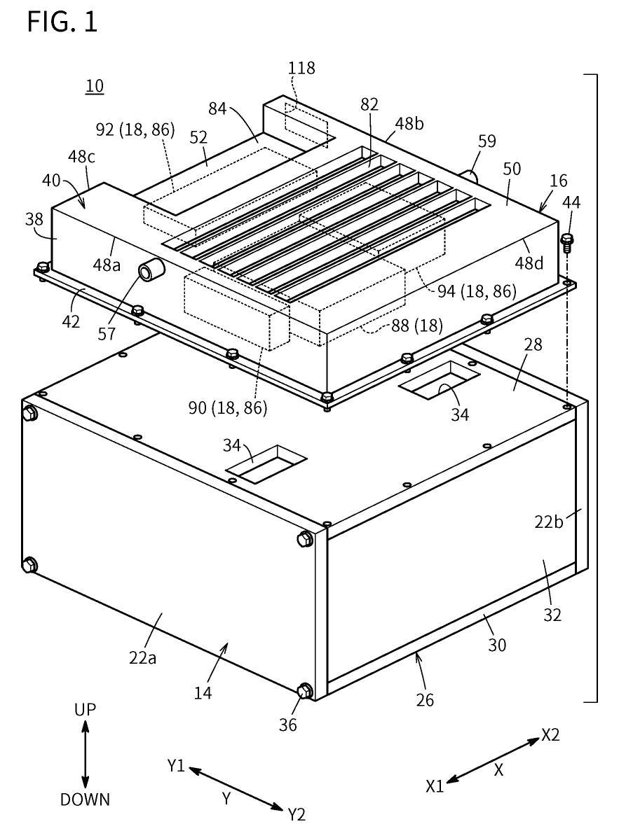

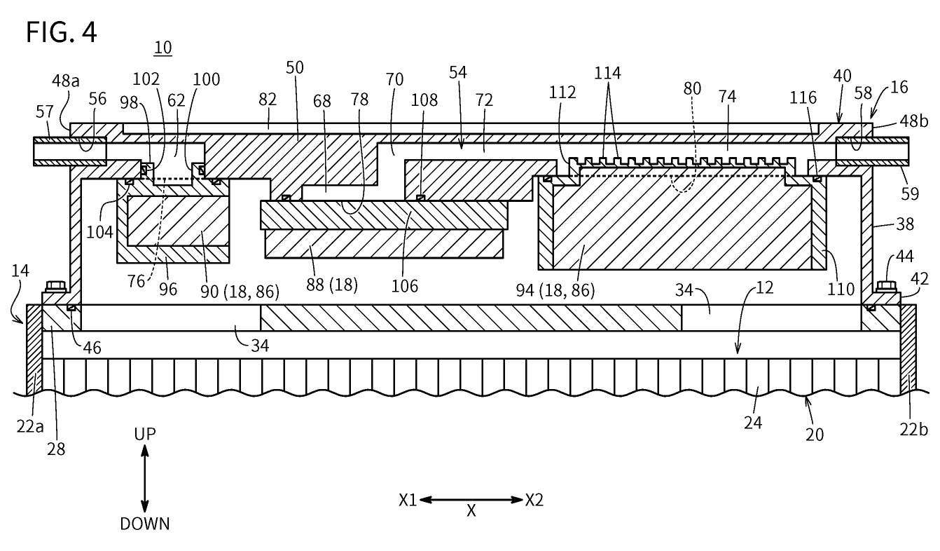

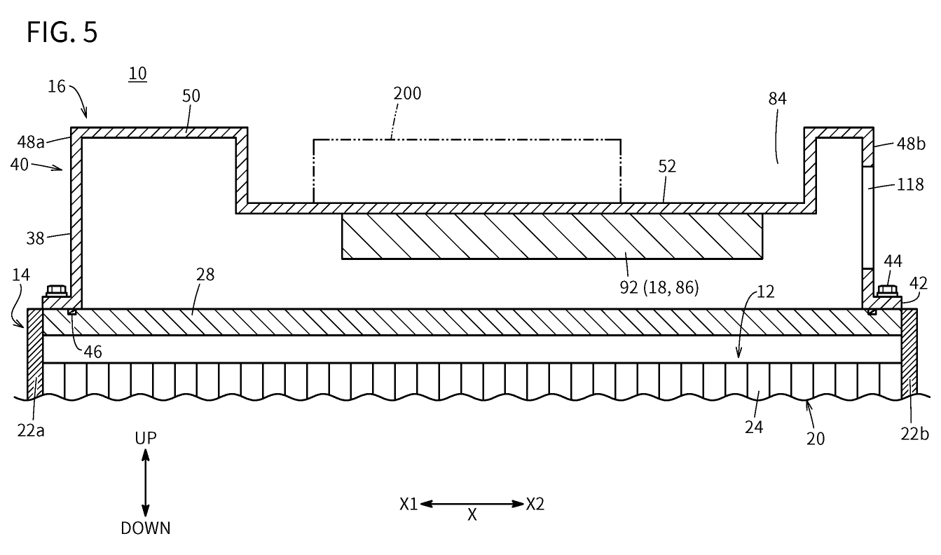

As shown in FIGS. 1 to 5, the fuel cell device 10 includes a fuel cell stack 12, a stack case 14, an electrical equipment case 16, and electrical equipment 18. As shown in FIGS. 4 and 5, the fuel cell stack 12 includes a cell stack body 20, and a pair of end plates 22a and 22b. Although other constituent elements may be included in the fuel cell stack 12 apart from these constituent elements, description of such elements will be omitted herein.

The cell stack body 20 is formed by stacking a plurality of power generation cells 24 on each other. The power generation cells 24 generate electric power by an electrochemical reaction between a fuel gas and an oxygen-containing gas. As the fuel gas, for example, hydrogen gas may be used. As the oxygen-containing gas, for example, air may be used.

As shown in FIG. 1, the stack case 14 accommodates the fuel cell stack 12 (see FIG. 4). The stack case 14 includes a peripheral wall case 26 and the pair of end plates 22a and 22b. The peripheral wall case 26 is formed in a quadrangular tubular shape, for example. The peripheral wall case 26 includes an upper plate 28, a lower plate 30, and a pair of side plates 32.

The upper plate 28 covers the fuel cell stack 12 from above. The upper plate 28 is formed in a quadrangular plate shape, for example. A pair of openings 34 are formed in the upper plate 28. The pair of openings 34 are arranged so as to be spaced apart from each other in the stacking direction of the plurality of power generation cells 24 (an X direction). Each opening 34 is formed in a quadrangular shape, for example. A bus bar (not shown) electrically connected to the fuel cell stack 12 is inserted through each opening 34.

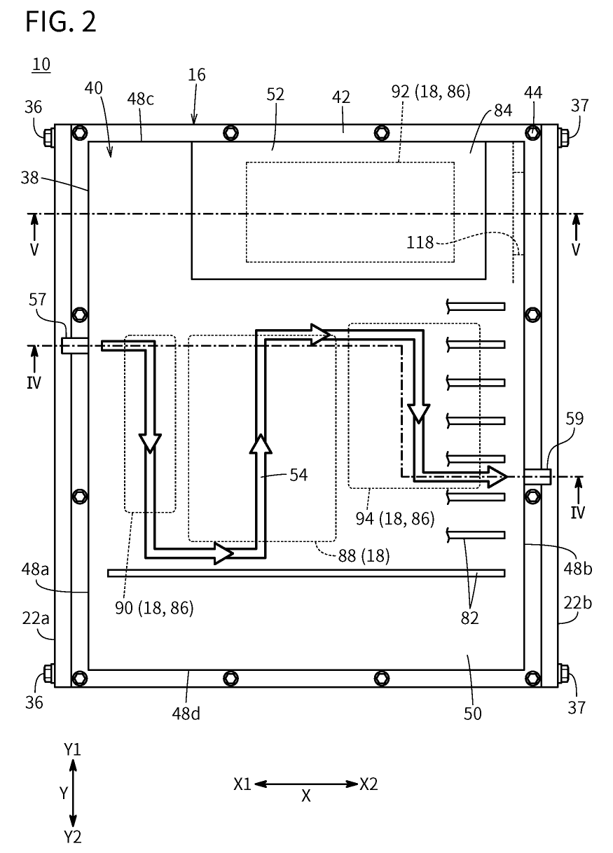

The end plate 22a is attached to one end surface (a surface facing in an X1 direction) of the peripheral wall case 26 by a plurality of bolts 36. The end plate 22b is attached to the other end surface (a surface facing in an X2 direction) of the peripheral wall case 26 by a plurality of bolts 37 (see FIG. 2).

The electrical equipment case 16 is open downward (see FIGS. 4 and 5). The electrical equipment case 16 includes a peripheral wall portion 38 and an upper wall portion 40. That is, the electrical equipment case 16 does not include a lower wall portion (a bottom wall portion). Accordingly, the height dimension of the electrical equipment case 16 is reduced as compared to a case where the electrical equipment case 16 is provided with the lower wall portion, and thus the size of the fuel cell device 10 can be reduced. In addition, the weight of the fuel cell device 10 can be reduced, and the manufacturing cost of the fuel cell device 10 can also be reduced.

The electrical equipment case 16 is integrally formed of, for example, an aluminum alloy. The electrical equipment case 16 may be made of a metal material other than an aluminum alloy, or may be made of a resin material.

As shown in FIG. 1, the peripheral wall portion 38 extends in an annular shape (for example, a quadrangular annular shape). The peripheral wall portion 38 extends in the up-down direction. A flange portion 42 is provided at a lower end portion of the peripheral wall portion 38. The flange portion 42 is attached to the upper plate 28 of the stack case 14 by a plurality of bolts 44. In other words, the peripheral wall portion 38 of the electrical equipment case 16 is attached to the stack case 14. That is, the electrical equipment case 16 is located above the fuel cell stack 12. A seal member 46 for sealing the interior of the electrical equipment case 16 is disposed between the upper plate 28 of the stack case 14 and the flange portion 42 (see FIGS. 4 and 5).

As shown in FIGS. 1, 4,and 5, the upper wall portion 40 of the electrical equipment case 16 is connected to an upper end portion of the peripheral wall portion 38. The upper wall portion 40 is formed in a plate shape. The upper wall portion 40 covers the upper plate 28 of the stack case 14 from above. A plurality of bosses (not shown) for attaching a member or the like (not shown) may be provided on an outer surface (a surface facing upward) of the upper wall portion 40.

As shown in FIG. 2, the upper wall portion 40 includes a first edge portion 48a, a second edge portion 48b, a third edge portion 48c, and a fourth edge portion 48d. The first edge portion 48a forms an edge portion of the upper wall portion 40 in the X1 direction. The second edge portion 48b is located opposite to the first edge portion 48a. That is, the second edge portion 48b forms an edge portion of the upper wall portion 40 in the X2 direction. The third edge portion 48c forms an edge portion of the upper wall portion 40 on one side in a Y direction (an edge portion of the upper wall portion 40 in a Y1 direction). The Y direction is a direction orthogonal to the X direction and the up-down direction. The fourth edge portion 48d forms an edge portion of the upper wall portion 40 on the other side in the Y direction (an edge portion of the upper wall portion 40 in a Y2 direction).

The upper wall portion 40 includes a first part 50 and a second part 52. A cooling medium flow path 54 through which a cooling medium for cooling the electrical equipment 18 flows is formed in the first part 50. The cooling medium is, for example, water. The cooling medium may contain ethylene glycol. The first part 50 has a water-cooling structure for cooling the electrical equipment 18.

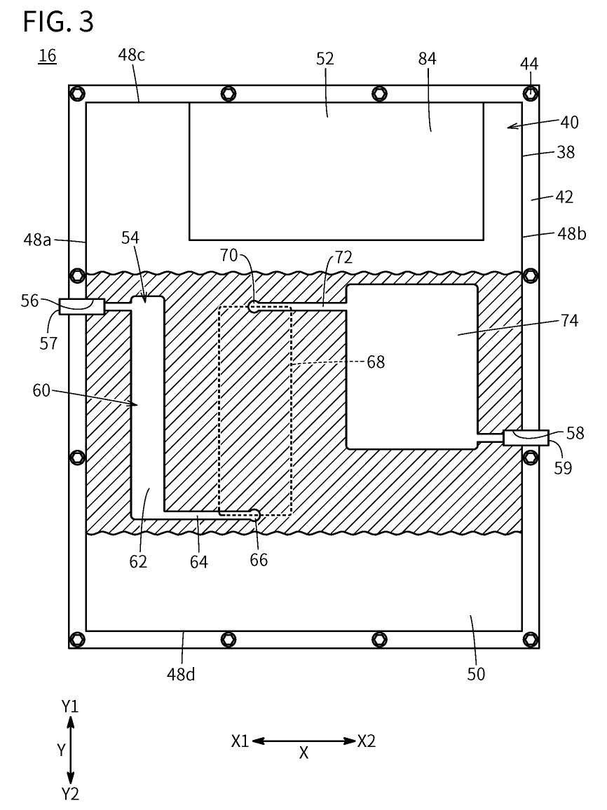

As shown in FIG. 3, the cooling medium flow path 54 includes a cooling medium inlet 56, a cooling medium outlet 58, and an intermediate flow path 60. The cooling medium inlet 56 is formed in the first edge portion 48a. An inlet port member 57 for connecting a cooling medium introduction pipe (not shown) is disposed at the cooling medium inlet 56. The cooling medium outlet 58 is formed in the second edge portion 48b. An outlet port member 59 for connecting a cooling medium lead-out pipe (not shown) is disposed at the cooling medium outlet 58.

The intermediate flow path 60 includes a meandering portion. The intermediate flow path 60 includes a first cooling flow path 62, a first connection flow path 64, a first communication hole 66, a second cooling flow path 68, a second communication hole 70, a second connection flow path 72, and a third cooling flow path 74.

The first cooling flow path 62 is adjacent to the first edge portion 48a. The first cooling flow path 62 extends in the Y direction. The cooling medium inlet 56 is connected to an end portion of the first cooling flow path 62 in the Y1 direction. The first cooling flow path 62 includes a first opening 76 that is open in an inner surface (a surface facing downward) of the first part 50 (see FIG. 4). The first connection flow path 64 is connected to an end portion of the first cooling flow path 62 in the Y2 direction.

The first connection flow path 64 extends in the X2 direction from the end portion of the first cooling flow path 62 in the Y2 direction. The first communication hole 66 is connected to an end portion of the first connection flow path 64 in the X2 direction. The first communication hole 66 extends downward from the end portion of the first connection flow path 64 in the X2 direction. A lower end of the first communication hole 66 is connected to the second cooling flow path 68. The second cooling flow path 68 is located on the X2 direction side of the first cooling flow path 62. The second cooling flow path 68 extends in the Y direction. The second cooling flow path 68 includes a second opening 78 that is open in the inner surface (the surface facing downward) of the first part 50 (see FIG. 4). The second communication hole 70 is connected to an end portion of the second cooling flow path 68 in the Y1 direction.

The second communication hole 70 extends upward from the end portion of the second cooling flow path 68 in the Y1 direction. The second connection flow path 72 is connected to an upper end portion of the second communication hole 70. The second connection flow path 72 extends in the X2 direction from the upper end portion of the second communication hole 70. The third cooling flow path 74 is connected to an end portion of the second connection flow path 72 in the X2 direction. The third cooling flow path 74 is adjacent to the second edge portion 48b. The third cooling flow path 74 extends in the Y direction. The third cooling flow path 74 includes a third opening 80 that is open in the inner surface (the surface facing downward) of the first part 50 (see FIG. 4). The second connection flow path 72 is connected to an end portion of the third cooling flow path 74 in the Y1 direction. The cooling medium outlet 58 is connected to an end portion of the third cooling flow path 74 in the Y2 direction. When viewed from above, the second cooling flow path 68 is located between the first cooling flow path 62 and the third cooling flow path 74.

As shown in FIGS. 1 and 2, a plurality of heat dissipation fins 82 are provided on an outer surface (a surface facing upward) of the first part 50 (the electrical equipment case 16). Accordingly, the electrical equipment 18 accommodated in the electrical equipment case 16 can be efficiently cooled by the plurality of heat dissipation fins 82. The heat dissipation fins 82 also function as ribs that increase the strength of the first part 50. The plurality of heat dissipation fins 82 are disposed in an intermediate portion of the upper wall portion 40 in the Y direction. Each of the heat dissipation fins 82 extends in the X direction. The plurality of heat dissipation fins 82 are arranged at intervals in the Y direction. The plurality of heat dissipation fins 82 are disposed above the cooling medium flow path 54. That is, the plurality of heat dissipation fins 82 are adjacent to the cooling medium flow path 54. Accordingly, the heat transferred to the cooling medium flowing through the cooling medium flow path 54 can be released into the air via the plurality of heat dissipation fins 82. The plurality of heat dissipation fins 82 are provided above the first cooling flow path 62, the second cooling flow path 68, and the third cooling flow path 74.

As shown in FIGS. 1, 2 and 5, the second part 52 forms a bottom wall portion of a recess 84 formed in the upper wall portion 40. As shown in FIG. 1, the second part 52 is located at an end portion of the upper wall portion 40 in the Y1 direction. The second part 52 is located below the first part 50. A step is formed between the first part 50 and the second part 52. An outer surface (a surface facing upward) of the second part 52 is located below the outer surface (the surface facing upward) of the first part 50. A component 200 (see FIG. 5) may be disposed in the recess 84 of the upper wall portion 40. Accordingly, even in the case where a member (not shown) is located above the second part 52, interference between the member and the component 200 can be avoided. Further, even in such a case, the heat in the electrical equipment case 16 can be released from the second part 52 into the recess 84.

As shown in FIGS. 1, 2, 4, and 5, the electrical equipment 18 is attached to the upper wall portion 40 (an inner surface of the upper wall portion 40). In other words, the electrical equipment 18 is suspended from the upper wall portion 40. The electrical equipment 18 includes, for example, a voltage conversion unit 86 and a control device 88. Although other constituent elements may be included in the electrical equipment 18 apart from these constituent elements, description of such elements will be omitted herein.

The voltage conversion unit 86 is electrically connected to the fuel cell stack 12 via the bus bars (not shown). The electric power generated by the fuel cell stack 12 can be boosted by the voltage conversion unit 86 and supplied to a non-illustrated load (for example, a drive device such as a motor) or the like. Further, the electric power generated by the fuel cell stack 12 can be boosted by the voltage conversion unit 86 and supplied to a battery (not shown).

The voltage conversion unit 86 is, for example, a DC-DC converter. The voltage conversion unit 86 includes a capacitor 90, a switching circuit portion 92, and a reactor 94. Although other constituent elements may be included in the voltage conversion unit 86 apart from these constituent elements, description of such elements will be omitted herein.

The capacitor 90 can smooth the voltage supplied from the fuel cell stack 12. The switching circuit portion 92 can boost the voltage supplied from the capacitor 90. The switching circuit portion 92 includes a plurality of switching elements (not shown). The reactor 94 can smooth the electric current supplied from the switching circuit portion 92. The control device 88 includes, for example, an intelligent power module (IPM). The control device 88 can control the switching circuit portion 92. The control device 88 can be supplied with electric power from a battery (not shown), for example.

As shown in FIG. 4, the capacitor 90, the control device 88, and the reactor 94 are cooled (water-cooled) by the cooling medium flowing through the cooling medium flow path 54 in a state of being attached to the inner surface of the first part 50. The cooling medium flow path 54 is located above the capacitor 90, the control device 88, and the reactor 94. As a result, the amount of cosmic rays falling on the electrical equipment 18 (the capacitor 90, the control device 88, and the reactor 94) from above the electrical equipment case 16 can be reduced by the cooling medium flowing through the cooling medium flow path 54. Therefore, it is possible to suppress malfunctioning or failure of the electrical equipment 18 (the capacitor 90, the control device 88, and the reactor 94) caused by cosmic rays.

Specifically, when the electrical equipment 18 is irradiated with cosmic rays, the electrical equipment 18 may malfunction or fail. In particular, in the case of a high-voltage component such as the voltage conversion unit 86, a failure or the like caused by cosmic rays is likely to occur. The cooling medium (for example, water) has a relatively low transmittance to cosmic rays (has a relatively large effect of shielding cosmic rays). Therefore, by providing the cooling medium flow path 54 above the electrical equipment 18, the amount of cosmic rays arriving at and transmitted through the electrical equipment 18 can be reduced by the cooling medium flowing through the cooling medium flow path 54. In particular, in the case where the vehicle equipped with the fuel cell device 10 travels on a highland road or in the case where the power generation system equipped with the fuel cell device 10 is installed at a highland site, the electrical equipment 18 can be effectively protected from cosmic rays by the cooling medium.

The capacitor 90 is located below the first cooling flow path 62. The capacitor 90 is attached to the inner surface of the first part 50 via a capacitor support member 96. The capacitor support member 96 supports the capacitor 90. The capacitor support member 96 extends along, for example, the Y direction. Examples of the constituent material of the capacitor support member 96 include, but are not limited to, a metal material. The capacitor support member 96 is attached to the inner surface of the first part 50 by, for example, a plurality of bolts (not shown).

The capacitor support member 96 is disposed so as to close the first opening 76. The cooling medium flowing through the first cooling flow path 62 contacts the capacitor support member 96. As a result, since the heat of the capacitor 90 is transferred to the cooling medium via the capacitor support member 96, the capacitor 90 can be efficiently cooled.

The capacitor support member 96 includes a protrusion 98 protruding from the first opening 76 into the first cooling flow path 62. A groove 100 for circulating the cooling medium is formed in an upper end surface of the protrusion 98. As a result, since the contact area between the capacitor support member 96 and the cooling medium can be made relatively large, the capacitor 90 can be more efficiently cooled.

A seal member 102 for preventing the cooling medium flowing through the first cooling flow path 62 from leaking to the outside is provided between an outer peripheral surface of the protrusion 98 and an inner surface of the first cooling flow path 62. In addition, a seal member 104 for preventing the cooling medium flowing through the first cooling flow path 62 from leaking to the outside is provided between the capacitor support member 96 and the inner surface of the first part 50.

The capacitor support member 96 is in contact with an upper surface of the capacitor 90, a side surface of the capacitor 90, and a bottom surface of the capacitor 90. This makes it possible to efficiently transfer the heat of the capacitor 90 to the capacitor support member 96. The shape, size, and the like of each of the capacitor 90 and the capacitor support member 96 can be set as appropriate.

The control device 88 is located below the second cooling flow path 68. The control device 88 is attached to the inner surface of the first part 50 via a support member 106. The support member 106 supports the control device 88. The control device 88 is attached to a lower surface of the support member 106. The support member 106 is, for example, a plate-shaped member extending along the Y direction. Examples of the constituent material of the support member 106 include, but are not limited to, a metal material. The support member 106 is attached to the inner surface (a lower surface) of the first part 50 by a plurality of bolts (not shown).

The support member 106 is disposed so as to close the second opening 78. The cooling medium flowing through the second cooling flow path 68 contacts the support member 106. As a result, since the heat of the control device 88 is transferred to the cooling medium via the support member 106, the control device 88 can be efficiently cooled.

A seal member 108 for preventing the cooling medium flowing through the second cooling flow path 68 from leaking to the outside is provided between an upper surface of the support member 106 and the inner surface of the first part 50. The shape, size, and the like of each of the control device 88 and the support member 106 can be set as appropriate.

The reactor 94 is located below the third cooling flow path 74. The reactor 94 is attached to the inner surface of the first part 50 via a reactor support member 110. The reactor support member 110 supports the reactor 94. Examples of the constituent material of the reactor support member 110 include, but are not limited to, a metal material. The reactor support member 110 is attached to the inner surface of the first part 50 by, for example, bolts (not shown).

The reactor support member 110 is disposed so as to close the third opening 80. The cooling medium flowing through the third cooling flow path 74 contacts the reactor support member 110. As a result, since the heat of the reactor 94 is transferred to the cooling medium via the reactor support member 110, the reactor 94 can be efficiently cooled.

The reactor support member 110 includes a protruding portion 112 protruding from the third opening 80 into the third cooling flow path 74. A plurality of projections 114 are provided on an upper end surface of the protruding portion 112. As a result, since the contact area between the reactor support member 110 and the cooling medium can be made relatively large, the reactor 94 can be more efficiently cooled.

A part of the reactor 94 is located in the third cooling flow path 74. Therefore, the reactor 94 can be more efficiently cooled. A seal member 116 for preventing the cooling medium flowing through the third cooling flow path 74 from leaking to the outside is provided between the reactor support member 110 and the inner surface of the first part 50. The shape, size, and the like of each of the reactor 94 and the reactor support member 110 can be set as appropriate.

As shown in FIG. 5, the switching circuit portion 92 is air-cooled in a state of being attached to an inner surface (a surface facing downward) of the second part 52. A ventilating opening 118 is formed in a portion of the peripheral wall portion 38 that is closed to the X2 direction side of the switching circuit portion 92. A filter member (not shown) can be disposed in the ventilating opening 118. The switching circuit portion 92 and the ventilating opening 118 face each other. The switching circuit portion 92 is cooled by air flowing through the electrical equipment case 16.

In the fuel cell device 10, since the heat generated in the fuel cell stack 12 during operation of the fuel cell stack 12 is transferred upward, the interior of the electrical equipment case 16 is likely to have a relatively high temperature. In the present embodiment, the cooling medium is introduced from the inlet port member 57. The cooling medium introduced into the inlet port member 57 cools the capacitor 90 while flowing through the first cooling flow path 62. The cooling medium that has flowed through the first cooling flow path 62 is guided to the second cooling flow path 68 via the first connection flow path 64 and the first communication hole 66. The cooling medium guided to the second cooling flow path 68 cools the control device 88 while flowing through the second cooling flow path 68. The cooling medium that has flowed through the second cooling flow path 68 is guided to the third cooling flow path 74 via the second communication hole 70 and the second connection flow path 72. The cooling medium guided to the third cooling flow path 74 cools the reactor 94 while flowing through the third cooling flow path 74. The cooling medium guided to the third cooling flow path 74 is discharged to the outside via the outlet port member 59.

That is, in the fuel cell device 10, the cooling medium flowing through the cooling medium flow path 54 cools the capacitor 90, then cools the control device 88 that is more likely to have a high temperature than the capacitor 90, and then cools the reactor 94 that is more likely to have a high temperature than the control device 88. This makes it possible to efficiently cool the capacitor 90, the control device 88, and the reactor 94. Further, by air-cooling the switching circuit portion 92 of the electrical equipment 18, the cooling medium flow path 54 can be configured compactly.

According to the present embodiment, the electrical equipment 18 accommodated in the electrical equipment case 16 can be cooled by the cooling medium flowing through the cooling medium flow path 54 formed in the electrical equipment case 16. As a result, even in the case where the electrical equipment case 16 is located above the fuel cell stack 12, it is possible to suppress an excessive increase in the temperature of the electrical equipment 18.

The fuel cell device 10 is not limited to having the above-described configuration. The cooling medium flow path 54 may be formed in each of the upper wall portion 40 and the peripheral wall portion 38 of the electrical equipment case 16. Further, the cooling medium flow path 54 may be formed in the peripheral wall portion 38 instead of the upper wall portion 40. The electrical equipment case 16 may include a bottom wall portion in addition to the upper wall portion 40 and the peripheral wall portion 38. In this case, the electrical equipment 18 may be disposed on the bottom wall portion of the electrical equipment case 16, and the electrical equipment case 16 may be configured to cover the electrical equipment 18 from above. Further, the electrical equipment 18 is not limited to having the configuration of being suspended from the upper wall portion 40 (the inner surface of the upper wall portion 40), and may be disposed on the upper plate 28 of the stack case 14, or may be held by the electrical equipment case 16 using an electrical equipment mounting base formed on the upper wall portion 40.

The following supplementary notes are further disclosed in relation to the above-described embodiment.

### Supplementary Note 1

The fuel cell device (10) of the present disclosure includes: the fuel cell stack (12) including the plurality of power generation cells (24) stacked on each other; the stack case (14) configured to accommodate the fuel cell stack; and the electrical equipment case (16) that is located above the fuel cell stack, is attached to the stack case, and is configured to accommodate the electrical equipment (18), wherein the cooling medium flow path (54) through which the cooling medium is allowed to flow is formed in the electrical equipment case.

According to such a configuration, the electrical equipment accommodated in the electrical equipment case can be cooled by the cooling medium flowing through the cooling medium flow path formed in the electrical equipment case. As a result, even in the case where the electrical equipment case is located above the fuel cell stack, it is possible to suppress an excessive increase in the temperature of the electrical equipment.

### Supplementary Note 2

In the fuel cell device according to Supplementary Note 1, the cooling medium flow path may be formed in the upper wall portion (40) of the electrical equipment case.

According to such a configuration, the amount of cosmic rays falling on the electrical equipment from above the electrical equipment case can be reduced by the cooling medium flowing through the cooling medium flow path. Therefore, it is possible to suppress malfunctioning or failure of the electrical equipment caused by cosmic rays.

### Supplementary Note 3

In the fuel cell device according to Supplementary Note 2, the cooling medium flow path may include the meandering portion.

According to such a configuration, the length of the cooling medium flow path can be increased without increasing the size of the electrical equipment case. Accordingly, the electrical equipment can be more efficiently cooled.

### Supplementary Note 4

In the fuel cell device according to Supplementary Note 2 or 3, the electrical equipment may be attached to the upper wall portion of the electrical equipment case.

According to such a configuration, since the electrical equipment can be disposed relatively close to the cooling medium flow path, the electrical equipment can be more efficiently cooled.

### Supplementary Note 5

In the fuel cell device according to Supplementary Note 4, the electrical equipment case may be open downward, and the peripheral wall portion (38) of the electrical equipment case may be attached to the stack case.

According to this configuration, since the height dimension of the electrical equipment case can be reduced, the size of the fuel cell device can be reduced. In addition, the weight of the fuel cell device can be reduced, and the manufacturing cost of the fuel cell device can also be reduced.

### Supplementary Note 6

In the fuel cell device according to any one of supplementary notes 1 to 5, the heat dissipation fin (82) may be provided on the outer surface of the electrical equipment case.

According to such a configuration, the electrical equipment can be efficiently cooled by the heat dissipation fin.

### Supplementary Note 7

In the fuel cell device according to Supplementary Note 6, the heat dissipation fin may be adjacent to the cooling medium flow path.

According to such a configuration, the heat transferred to the cooling medium flowing through the cooling medium flow path can be released into the air via the heat dissipation fin.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A fuel cell device comprising:
a fuel cell stack including a plurality of power generation cells stacked on each other;
a stack case configured to accommodate the fuel cell stack; and
an electrical equipment case that is located above the fuel cell stack, is attached to the stack case, and is configured to accommodate electrical equipment,
wherein a cooling medium flow path through which a cooling medium is allowed to flow is formed in the electrical equipment case.

2. The fuel cell device according to claim 1, wherein
the cooling medium flow path is formed in an upper wall portion of the electrical equipment case.

3. The fuel cell device according to claim 2, wherein
the cooling medium flow path includes a meandering portion.

4. The fuel cell device according to claim 2, wherein
the electrical equipment is attached to the upper wall portion of the electrical equipment case.

5. The fuel cell device according to claim 4, wherein
the electrical equipment case is open downward, and
a peripheral wall portion of the electrical equipment case is attached to the stack case.

6. The fuel cell device according to claim 1, wherein
a heat dissipation fin is provided on an outer surface of the electrical equipment case.

7. The fuel cell device according to claim 6, wherein
the heat dissipation fin is adjacent to the cooling medium flow path.
